(19) United States
(12) Patent Application Publication
(10) Pub. No.: US 2006/0272012 A1
(43) Pub. Date: Nov. 30, 2006

(54) Multifunction server system

(76) Inventor: Chao-Hung Wu, Hsintien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/139,473

(22) Filed: May 31, 2005

(51) Int. Cl. H04L 9/32

(52) U.S. Cl. 726/6

(57) ABSTRACT

A multifunction server system is proposed in the present invention to eliminate the drawbacks of conventional server systems. More particularly, the present invention is related to a multifunction server that connects with at least a host computer to form an enterprise intranet and provides services, such as bandwidth management, data management and data security, via software programs installed therein. The present invention performs better when processing multimedia data.

### BACKGROUND OF THE INVENTION

1. Field of the Invention

The present invention is related to a multifunction server system, and more particularly, to a multifunction server that connects with at least a host computer to form an enterprise intranet and provide services, such as bandwidth management, data management and data security, via software programs installed therein.

2. Description of Related Art

With the prevalence of the Internet, individuals or enterprises increasingly rely on computer networks. With regard to individuals, only one computer is needed for network access. However, for enterprises, the number of computers is larger and thus at least a server is needed to manage the intranet formed by the computers and connected with the Internet. Reference is made to FIG. 1, which is a schematic diagram of an internal architecture of a conventional server. Briefly, a server 10 can be a powerful personal computer (PC). It has a central processing unit (CPU) 11 and a memory unit 12 inside to perform high-speed logic operation and signal processing. The server 10 usually has a database 13 to further meet the data requirements of the computers connected thereto.

Since every computer of the intranet connects to Internet via the server 10, the increase of the amount of computers connected to the intranet or the increase of the intranet's loading, such as a sudden access or transmission of large video files, needs a larger bandwidth resource to connect to Internet.

Otherwise, once the bandwidth resource is insufficient, the access speed of each computer will become very slow. Besides, the increase of the computers or the sudden access of video files also makes the server 10 suffer a very large operative loading. As the data volumes of multimedia files become increasingly large, the bandwidth problem caused thereby has become an important issue.

In addition to bandwidth, data security is another issue that concerns users. In the prior art, a firewall program is installed on the server 10. This method is low-cost and simple. However, there are some potential problems in this method. Once the firewall program is broken, the Internet Protocol (IP) addresses can be obtained easily via access of packets. That may make computers suffer virus attacks or allow illegal access of the resources of the computers.

Another method for data security is to install a firewall computer devoted to security management at the front end of the server 10. In this way, the address-converting function need not be performed via packets transfer. Thus, hackers do not have any chance to obtain IP addresses of the intranet.

In these days, multimedia transmission is increasingly popular. Data security, transmission quality and data management have become main research topics for next information reformation.

### SUMMARY OF THE INVENTION

An objective of the present invention is to provide a multifunction server system, and more particularly, to a multifunction server that connects with at least a host computer to form an enterprise intranet and provide services, such as bandwidth management, data management and data security, via software programs installed therein. In the services mentioned above, the present invention has a better performance in the processing of multimedia data.

The multifunction server system of the present invention includes a multifunction server and at least a host. The host has a multimedia application program installed therein and connects to the multifunction server via a network interface. The host can further have a restoring program to restore the original state of the host. The multifunction server uses the software programs installed therein to meet various requirements and connect to the Internet. The multifunction server includes a central processing unit (CPU) and a memory unit. In order to store more data files or software programs, the multifunction server further has a database or a storage unit. The memory unit has at least one of the software programs, which is executed by the CPU to perform a data security function, a bandwidth management function and/or a data management function. Thus, the multifunction server manages and controls the host to form an enterprise intranet to provide the functions of the software programs.

The software programs that are executable for the CPU include a first program for bandwidth management, which is used to determine automatically deliver paths of data packets; a second program for data management, which is used to store (or backup) or monitor data or deliver documents; and a third program for data security, which uses a picture-capturing technique, an identity (ID) identification technique and/or a system programming languages changing technique (or system programming protocol changing technique) to provide the data security function.

The first program automatically determines that the data packet needs to be delivered via the enterprise intranet or the Internet so it has the bandwidth management function. The second program provides a web page for the host to access the data stored in the multifunction server so that the multifunction server can store (or backup) or monitor the data or deliver the documents. The picture-capturing technique used by the third program is that the host only accesses image files converted from the data stored in the multifunction server, not the data itself. Thus, the third program prevents the hosts from accessing viruses attached to the data. Finally, the system programming languages changing technique (or system programming protocol changing technique) used in the third program changes the programming language (or the programming protocol) used in the hosts and the multifunction server to make the multimedia application programs installed in the hosts able to cooperate with the programming language (or the programming protocol) of the multifunction server. Thus, via the change of programming format, virus infection is prevented.

The multifunction server system can further include a second server connected to the multifunction server and the hosts. Furthermore, the multifunction server system can also include a firewall computer system or a firewall program connected to the multifunction server. Due to the ID identification technique used in the third program, only the multifunction server can pass the identification procedure of the firewall computer system or the firewall program to connect with the Internet.

Numerous additional features, benefits and details of the present invention are described in the detailed description, which follows.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic diagram of an internal architecture of a conventional server;

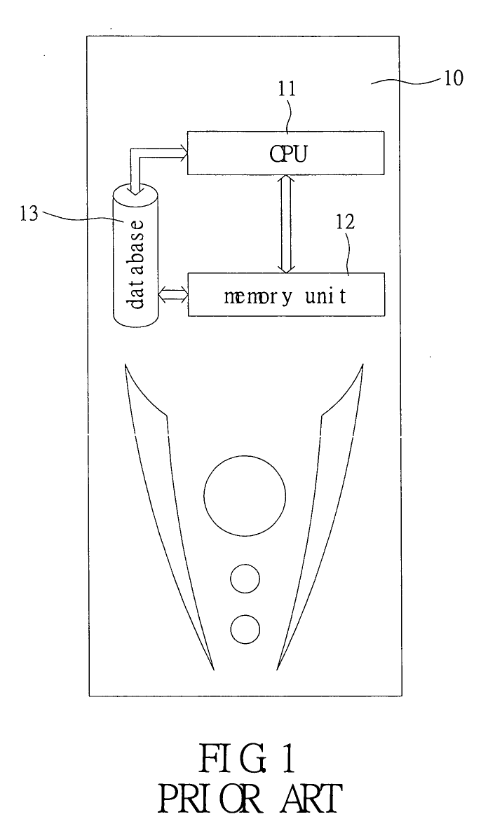

FIG. 2 is a schematic diagram of a multifunction server system in accordance with the first embodiment of the present invention

FIG. 3 is a schematic diagram of a multifunction server system in accordance with the second embodiment of the present invention; and

FIG. 4 is a schematic diagram of a multifunction server system in accordance with the third embodiment of the present invention.

### DETAILED DESCRIPTION OF PREFERRED EMBODIMENTS

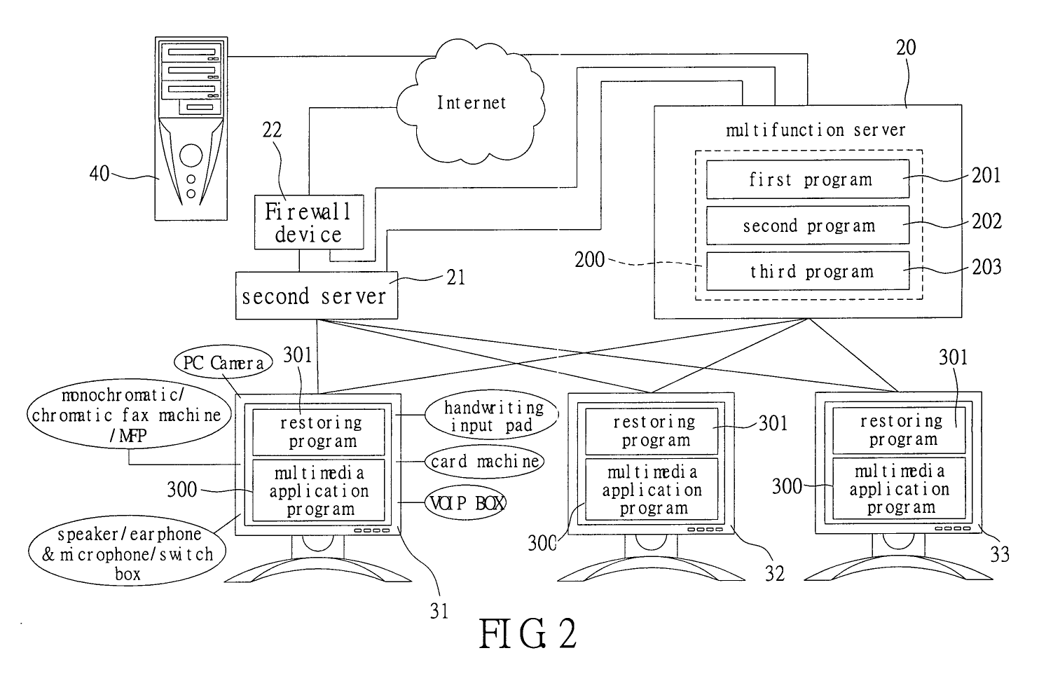

Reference is made to FIG. 2, which is a schematic diagram of a multifunction server system in accordance with the first embodiment of the present invention. The multifunction server system has a multifunction server 20, a second server 21, a Firewall device 22, such a Firewall computer system or a Firewall program, a first host 31, a second host 32 and a third host 33. The multifunction server 20 is connected to the Internet directly or via the Firewall device 22. The second server 21 is connected to the multifunction server 20 and connected to the Internet via the Firewall device 22. The first host 31, the second host 32, and the third host 33 are connected to both of the multifunction server 20 and the second server 21 via network interfaces. The multifunction server 20 is used to process multimedia messages, such as video mail, and the second server is used to process common e-mail.

The multifunction server 20 meets the multifunction requirements by executing software programs. It includes a central processing unit (CPU) and a memory unit. In order to store more data files or software programs, the multifunction server 20 further has a database or a storage unit. At least a software program is stored in the memory unit and the CPU executes the software program. In this way, the multifunction server 20 manages and controls the first host 31, the second host 32, and the third host 33, and an intranet is formed and has the functions of the software programs 200 executed by the multifunction server 20.

Each of the hosts, i.e. the first host 31, the second host 32 and the third host 33, has a multimedia application program 300 to provide multimedia applications, such as displaying a multimedia mail. The multimedia application program 300 can also be used for a user to read common e-mail. Each of the first host 31, the second host 32, and the third host 33 has a restoring program 301 installed therein. Each time the first host 31, the second host 32, and the third host 33 are turned off and then on again, the restoring program 301 restores the contents of the first host 31, the second host 32, and the third host 33 to prevent virus attacks and reduce the maintenance frequency.

The software programs 200 that can be executed in the multifunction server 20 include a first program 201 for bandwidth management, a second program 202 for data management, and a third program 203 for data security.

The first program 201 is used for automatic determination of the delivery paths for data packets. For example, if the first host 31 delivers a dialog video file or a video mail to a remote host 40, the multifunction server 20 will choose the Internet as the path to deliver the file or mail to the remote host 40; however, if the first host 31 sends a dialog video file or a video mail to the second host 32 or the third host 33, the multifunction server 20 will choose the intranet as the path. In the second example, the message delivery doesn't need to occupy the bandwidth resource for connection of the Internet. The multifunction server 20 manages the bandwidth resource effectively in this way. Hence, the Internet access speed of the present invention is higher than that of the prior art.

The second program 202 for data management is used for managing data storage (or backup), monitoring data or delivering documents. Since the data are stored in the multifunction server 20, a web page is provided by the second program 202 for access of the data. Thus, the multifunction server 20 can serve as a database or a mail delivering center used to deliver common text-only mail or multimedia mail. For example, one may log onto the web page to check and reply to the mail. Furthermore, the multifunction server 20 can manage or backup the data of the enterprise intranet, including video mail and the list and contents of common mail. The enterprise intranet includes the first host 31, second host 32, and third host 33. Furthermore, in order to reduce the loading or the occupied storage space of the multifunction server 20 or the second server 21, the hosts 31-33 can use the remote host 40 to deliver video mail or e-mail. Thus, servers' burden is lowered.

The third program 203 uses a picture-capturing technique, an identity (ID) identification technique and/or a system programming languages changing technique (or system programming protocol changing technique) to provide the data security function. The picture-capturing technique is that the hosts, i.e. the first host 31, the second host 32, and the third host 33, only access the image files converted from the data stored in the multifunction server 20, not the data itself. This prevents the hosts from accessing viruses attached to the data.

The system programming languages changing technique (or system programming protocol changing technique) changes the programming language (or the programming protocol) used in the hosts 31-33 and the multifunction server 20. For example, the Microsoft Windows OS usually used nowadays can be replaced by the Linux OS. The multimedia application programs installed in the hosts 31-33 are made to cooperate with the programming language (or the programming protocol) of the multifunction server 20. Thus, via the change of programming format, virus infection is prevented.

Finally, the ID identification technique is that only the multifunction server 20 can pass the identification procedure of the firewall device 22 (a firewall computer system or a firewall program) to connect to the Internet. Hence, the first host 31, the second host 32, and the third host 33 connected to the multifunction server 20 can pass the identification procedure of the firewall device 22, such as IP identification, via the multifunction server 20. The first host 31, the second host 32, and the third host 33 cannot pass the identification procedure of the firewall device 22 by themselves to transmit data. In this way, data security is provided.

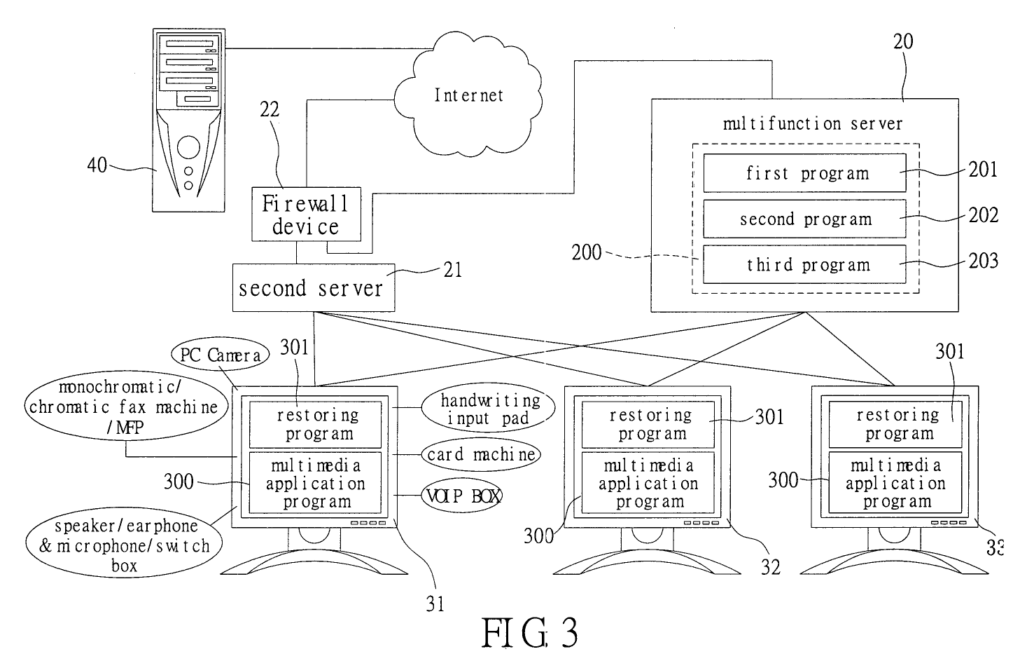

Reference is made to FIG. 3, which is a schematic diagram of a multifunction server system in accordance with the second embodiment of the present invention. Compared with the first embodiment, the second embodiment is different in that both of the multifunction server 20 and the second server 21 can only connect to the Internet via the firewall device 22. In the first embodiment, the multifunction server 20 can connect to the Internet directly or via the firewall device 22.

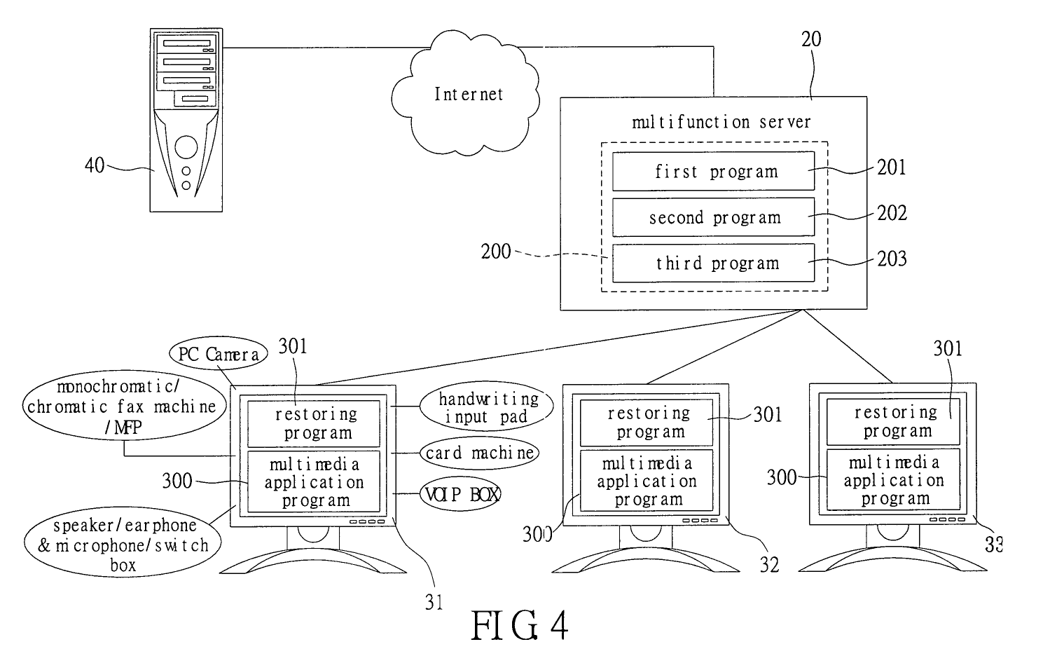

Reference is made to FIG. 4, which is a schematic diagram of a multifunction server system in accordance with the third embodiment of the present invention. Compared with other embodiments mentioned above, the third embodiment is different in that only the multifunction server 20 is used and the second server 21 is omitted. Therefore, the present invention meets various requirements. For example, the multifunction server 20 of the present invention can be applied either for the enterprises with or without a mail server to form a multifunction server system. In the services mentioned above, the present invention performs better when processing multimedia data.

The present invention has the advantages and functions as follows:
1. In the aspect of bandwidth management, the present invention can manage the outgoing packets and thus the inter-calling or mail delivery of the enterprise's computers can be performed directly via the intranet, without Internet access. Hence, the access efficiency is improved.
2. In the aspect of data management, the present invention can backup, store and monitor mail or data of an enterprise's computers and use external resources (for example, using an external server to send video mail).
3. In the aspect of data security, the present invention uses the picture-capturing technique, the ID identification technique or the programming format changing technique to protect data and prevent leakage. In addition, each of enterprise's computers has a restoring program installed therein to improve the efficiency of enterprise's management information system (MIS).

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are embraced within the scope of the invention as defined in the appended claims.

What is claimed is:

1. A multifunction server system, comprising:
a multifunction server meeting predetermined requirements by executing software programs and connecting to Internet; and
at least a host having a multimedia application program installed therein and connecting to the multifunction server via a network interface;
wherein the multifunction server further comprises:
a central processing unit (CPU); and
a memory unit having at least one software program, wherein the at least one software program is executed by the CPU to perform a data security function, a bandwidth management function and/or a data management function;
wherein the software programs comprises:
a first program for bandwidth management, wherein the first program is used to determine automatically a delivery path of a data packet;
a second program for data management, wherein the second program is used to store, backup, or monitor data, or deliver documents; and
a third program for data security, wherein the third program uses a picture-capturing technique, an identity (ID) identification technique, and/or a system programming languages changing technique (or system programming protocol changing technique) to provide the data security function;
wherein the multifunction server manages and controls the host connected thereto to form an enterprise intranet to provide the data security function, the bandwidth management function, and/or the data management function.

2. The multifunction server system as claimed in claim 1, wherein the multifunction server further has a database or a storage unit for storing data files or the software programs.

3. The multifunction server system as claimed in claim 1, wherein the host further has a restoring program, wherein the restoring program is used to restore the host after the host is first switched off and then switched on again.

4. The multifunction server system as claimed in claim 1, further comprising a second server connected to the multifunction server and the host to form the enterprise intranet.

5. The multifunction server system as claimed in claim 1, further comprising a firewall computer system or a firewall program connected to the multifunction server to protect the enterprise intranet.

6. The multifunction server system as claimed in claim 1, wherein the first program automatically determines the data packet needs to be delivered via the enterprise intranet or the Internet.

7. The multifunction server system as claimed in claim 1, wherein the second program stores data in the multifunction server and provides a web page for the host to access the data, whereby the multifunction server is able to store, backup, or monitor the data, or deliver the documents.

8. The multifunction server system as claimed in claim 1, wherein the picture-capturing technique used by the third program comprises the host accessing an image file converted from the data stored in the multifunction server.

9. The multifunction server system as claimed in claim 5, wherein the ID identification technique used by the third program is applied so that only the multifunction server can pass an identification procedure of the firewall computer system or the firewall program to connect to the Internet.

10. The multifunction server system as claimed in claim 1, wherein the system programming languages changing technique, or the system programming protocol changing technique, used by the third program changes a programming language or a programming protocol used in the host and the multifunction server and makes the host able to cooperate with the multifunction server.

11. A multifunction server system, comprising:
a multifunction server meeting predetermined requirements by executing software programs and connected to Internet;
a second server connected to the multifunction server; and
at least a host having a multimedia application program installed therein and connecting to the multifunction server and the second server via a network interface;
wherein the multifunction server further comprises:
a CPU; and
a memory unit having at least one software programs, wherein the at least one software program is executed by the CPU to perform a data security function, a bandwidth management function, and/or a data management function;
wherein the software programs comprises:
a first program for bandwidth management, wherein the first program is used to determine automatically a delivery path of a data packet;
a second program for data management, wherein the second program is used to store, backup, or monitor data, or deliver documents; and
a third program for data security, wherein the third program uses a picture-capturing technique, an identity (ID) identification technique, and/or a system programming languages changing technique or system programming protocol changing technique, to provide the data security function;
wherein the multifunction server manages and controls the host connected thereto to form an enterprise intranet to provide the data security function, the bandwidth management function, and/or the data management function.

12. The multifunction server system as claimed in claim 11, wherein the multifunction server further has a database or a storage unit for storing data files or the software programs.

13. The multifunction server system as claimed in claim 11, wherein the host further has a restoring program, wherein the restoring program is used to restore the host after the host is first switched off and then switched on again.

14. The multifunction server system as claimed in claim 11, further comprising a firewall computer system or a firewall program connected to the multifunction server to protect the enterprise intranet.

15. The multifunction server system as claimed in claim 11, wherein the first program automatically determines the data packet needs to be delivered via the enterprise intranet or the Internet.

16. The multifunction server system as claimed in claim 11, wherein the second program stores the data in the multifunction server and provides a web page for the host to access the data, whereby the multifunction server is able to store, or backup, or monitor the data, or deliver the documents.

17. The multifunction server system as claimed in claim 11, wherein the picture-capturing technique used by the third program comprises the host accessing an image file converted from the data stored in the multifunction server.

18. The multifunction server system as claimed in claim 14, wherein the ID identification technique used by the third program is applied so only the multifunction server can pass an identification procedure of the firewall computer system or the firewall program to connect to the Internet.

19. The multifunction server system as claimed in claim 11, wherein the system programming languages changing technique, or the system programming protocol changing technique, used by the third program changes a programming language or a programming protocol used in the host and the multifunction server and makes the host able to cooperate with the multifunction server.

20. A multifunction server, meeting predetermined requirements by executing software programs, the multifunction server comprising:
a CPU; and
a memory unit having at least one software program, wherein the at least one software program is executed by the CPU to perform a data security function, a bandwidth management function, and/or a data management function;
wherein the software programs comprises:
a first program for bandwidth management, wherein the first program is used to determine automatically a delivery path of a data packet;
a second program for data management, wherein the second program is used to store, backup, or monitor data, or deliver documents; and
a third program for data security, wherein the third program uses a picture-capturing technique, an identity (ID) identification technique and/or a system programming languages changing technique (or system programming protocol changing technique) to provide the data security function.

21. The multifunction server as claimed in claim 20, further connecting to at least a host via a network interface to form an enterprise intranet.

22. The multifunction server as claimed in claim 20, further comprising a database or a storage unit for storing data files and the software programs.
